(19) United States
(12) Patent Application Publication
(10) Pub. No.: US 2007/0284413 A1
(43) Pub. Date: Dec. 13, 2007

(54) Heat shield assembly

(76) Inventor: Michael J. Franklin, Fallon, NV (US)

Correspondence Address: Robert Charles Hill, 235 Montgomery Street #821, San Francisco, CA, 94104, US

(21) Appl. No.: 11/451,664

(22) Filed: Jun. 13, 2006

(51) Int. Cl. A47J 36/02

(52) U.S. Cl. 228/101

(57) ABSTRACT

A heat shield assembly for use in soldering, brazing, or welding applications, and more specifically in plumbing, refrigeration, or air conditioning systems where it is desirable to shield a temperature sensitive component from the heat source used to perform a soldering, brazing, or welding operation. An additional use for the heat shield assembly is to prevent bursts of steam or water vapor, emanating from a water soaked rag that has been wrapped around a temperature sensitive component in order to cool the component, from extinguishing the heating torch used to perform the soldering, brazing or welding operation. The heat shield assembly has a plurality of segments interconnected in a manner to allow each segment to move independently of its adjacent segment.

### BACKROUND OF INVENTION

1. Field of Invention

This invention pertains to a heat shield that is adjustable to fit around tubing or pipes, for example, in plumbing, heating or air conditioning applications. More specifically, when fastening sections of metal tubing or pipes together, or joining tubing or pipes to a particular element, such as a valve as part of an overall system, it is necessary to solder or braze the junctions together. In order to perform the brazing or soldering function it is necessary to heat the junction of the tubing or pipes so as to melt a solder or brazing material, allowing it to fill the voids between junctions of the tubing, pipes, or system elements, thus making a leak tight seal. The method of heating the tubing or pipes and the soldering or brazing material to a sufficient temperature normally requires the use of a flame-producing torch. The type of torch normally used requires the burning of a combustible gas such as butane for lower temperature applications and a combination of oxygen and acetylene for higher temperature applications. In either case, the temperatures encountered in the overall process are extreme and often exceed 500 hundred degrees Fahrenheit.

During the above soldering or brazing process a great deal of radiant heat is produced not only from the torch but also from the elements being heated. One object of this invention is to reduce the amount of heat radiated to any surrounding elements, such as a valve that might be part of an overall air conditioning system or plumbing application, or an adjacent wall surface that might be damaged. In the case of a valve or any such system component that might contain sealing elements such as o-rings it is desirable to keep the temperature of the component as low as possible during the soldering or brazing operation to avoid damage to the sealing elements.

It has been found in practical applications that the radiant heat from the heating torch will cause significant heating of an adjacent part, such as a valve, in addition to the conductive heat transfer through the tubing or pipe material being soldered or brazed. In addition, it has also been found that the radiant heat from the heating torch will cause significant discoloration of adjacent parts.

Another object of this invention involves protection of the heating torch from being extinguished by bursts of steam or water vapor from a water-soaked cooling rag that is often used when trying to reduce the heating of a system part, such as a valve, during the soldering or brazing operation. The process of wrapping a particular part, such as a valve, with a water-soaked rag is often referred to in the trade as “ragging” a part. As the valve or any such element becomes hot during the soldering or brazing operation the water content of the rag reaches a temperature at which steam or water vapor is produced. In practical situations it has been found that bursts of steam or water vapor, typically emanating from the folds of the rag, often cause the torch flame to become extinguished. This requires re-igniting the torch in order to proceed with the completion of the soldering or brazing. The extinguishing of the torch can occur several times before the soldering or brazing is completed, thereby causing considerable frustration for the technician and consuming valuable time.

Thus it can be seen that there are two primary objectives of this invention, namely, reduction of radiant heat from the area being soldered or brazed and reduction of the possibility of extinguishing of the heating torch during certain soldering and brazing operations.

2. Description of Prior Art

A search for prior art revealed two applicable heat shield patents. The first patent, U.S. Pat. No. 4,161,643, dated Jul. 17, 1979 and issued to Martin, Jr. et al, describes a heat shield which is used to shield a welder's hand from the radiant heat of a welding apparatus. A second patent, U.S. Pat. No. 6,561,409, dated May 13, 2003 and issued to Spirig, describes a heat shield that is fastened to a soldering device. Fastening the heat shield to the soldering device allows the heat shield to move in conjunction with the soldering device thereby shielding a target area from the radiant heat of the heat source. Neither of these inventions accomplishes the two primary objectives of the present invention.

### SUMMARY OF THE INVENTION

This invention involves the attachment of several segments of material, typically made of metal, together in such a manner as to produce an adjustable shield that can be placed around pipes of varying diameters. The shape of each segment is such that, when fastened to an adjacent segment, a means is provided for rotating the position of each segment relative to its adjacent segment, thereby allowing a series of segments to encompass the circumference of a pipe, tube, or other such object. The bottom portion of each segment has a concave arc so that when the heat shield is placed adjacent to a pipe, tube, or other such circular object it will minimize the space between the segments and the adjacent pipe, tube, or other such circular object, thus optimizing the shielding effect. The means of connecting the individual segments allows the segments to rotate independently of one another and typically involves the use of a rivet or other such fastening means. When fastening one segment to another segment with a rivet or other such fastening means, the flattening of the rivet during compression is such that it causes considerable friction between the two segments. Although the amount of rivet compression can be adjusted during production it has been found that the friction between the two segments becomes less and less as the segments are repeatedly rotated relative to one another. In order to maintain a desirable friction between each of the segments a spring element, in the form of a spring washer or wavy washer, has been inserted between the two segments as will be shown in the drawings. Thus, as the segments are rotated relative to one another, the wearing of the rivet and segment surfaces that would normally reduce the inter-segment friction will be compensated for by the spring washers or wavy washers.

### DESCRIPTION OF THE DRAWINGS

FIG. 1 shows an individual segment of the heat shield assembly.

FIG. 2 shows the heat shield assembly as it would be typically used by encompassing the circumference of a tube or pipe.

FIG. 3 shows three segments of the heat shield assembly located on the circumference of a tube or pipe for the purpose of describing the angular positioning of the segment holes and limits of the concave arc.

FIG. 4 shows a cross-sectional exploded side view of the individual items involved in the assembly of two segments of the overall heat shield.

FIG. 5 shows the side view of the individual items involved in the assembly of two segments of the overall heat shield after the segments are fastened together.

FIG. 6 shows a typical application of the heat shield with the heat shield located between the heat source and the item to be shielded.

FIG. 7 shows a typical application of the heat shield with the heat shield located between the heat source and the item to be shielded in which the item to be shielded is wrapped with a water-soaked rag.

### DETAILED DESCRIPTION

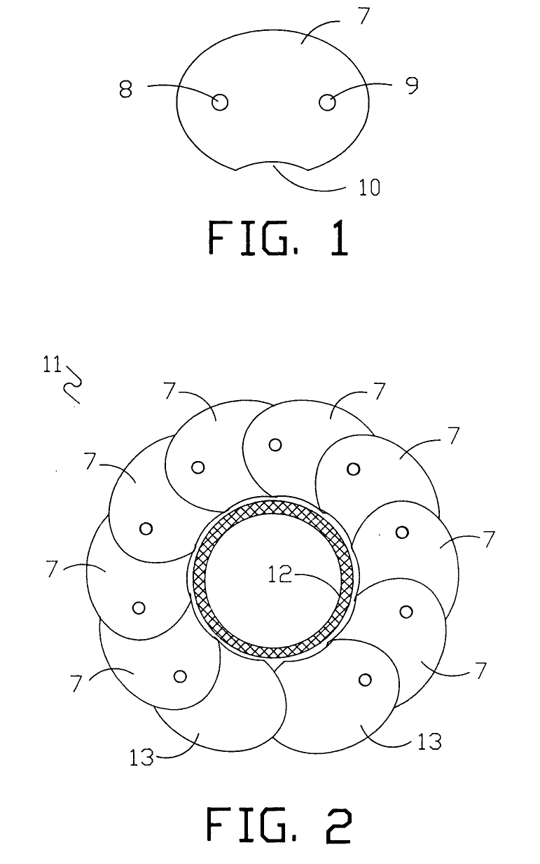

FIG. 1 shows a heat shield segment 7 with through holes 8 and 9. Segment 7, as shown, is fabricated from sheet metal, such as stainless steel, that is easily formed by stamping from a stock sheet metal material. Other appropriate materials such as ceramic could be used without departing from the spirit of the invention. One area of heat shield segment 7 is formed in the shape of a concave arc 10 in order to reduce the clearance between the heat shield and the circumference of tubing or a pipe as will be seen later.

FIG. 2 shows a heat shield assembly 11 composed of eight intermediate segments 7 and two end segments 13 arranged to encircle a pipe or tubing 12. The intermediate segments 7 and end segments 13 differ only in that intermediate segments 7 have two through holes to allow interconnection between adjacent segments, and end segments 13 have only one thru hole since they are used as end segments. The number of intermediate segments 7 used is for example only and it should be understood that any appropriate number of intermediate segments 7 can be used depending upon the circumference of the pipe, tube, or other object.

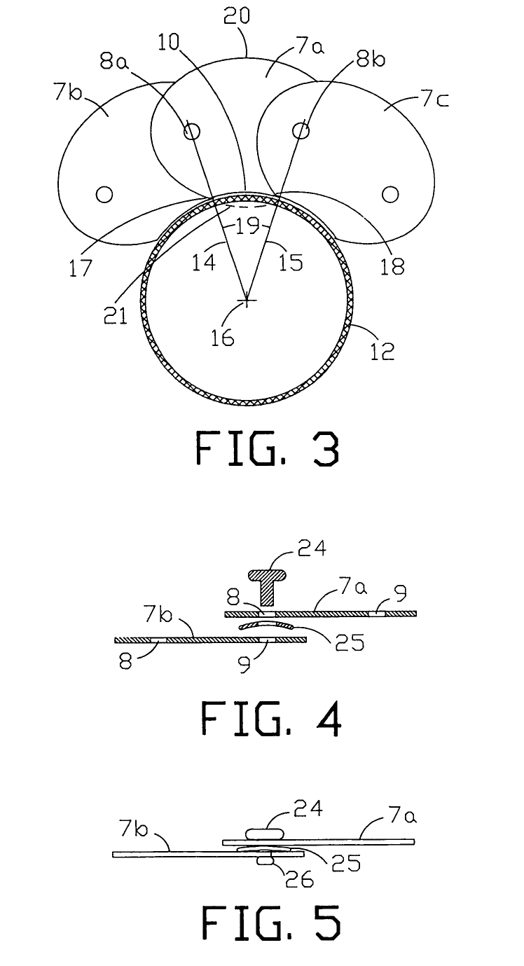

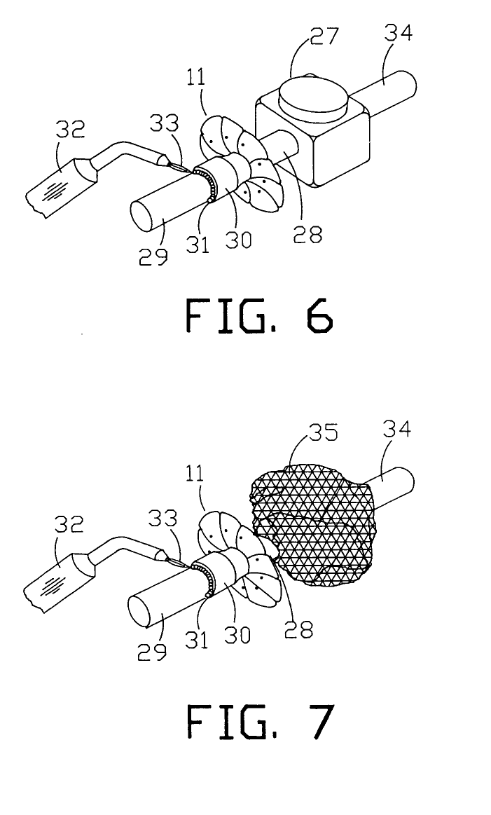

FIG. 3 shows three heat shield intermediate segments 7a, 7b, and 7c with radial lines 14 and 15 originating at the center 16 of tubing 12 and is shown to demonstrate the reasoning behind the segment 7 design, including the location of holes 8 and 8b, the location of the beginning 17 and end 18 of the concave arc 10, and finally the overall dimensions. Hole 8b is part of intermediate segment 7c and overlaps hole 9 (FIG. 4) of intermediate segment 7a. It was arbitrarily decided to set the upper diameter limit of tubing to be used with this particular heat shield assembly at two inches. Larger diameter tubing would require design of another heat shield assembly with the appropriate segment size, hole position, and concave arc or the use of multiple heat shield assemblies, clamped together at their ends in order to accommodate the larger diameter pipe or tubing. Computer simulation suggested that ten segments would give adequate shielding for the two-inch diameter tubing 12 and yet provide minimum spacing between the concave arc 10 and the outer circumference of tubing 12 in applications where tubing 12 might be one-half inch in diameter. The circumferential location of holes 8 and 9 in FIG. 4 is dictated by the number of segments to be used to encompass the largest diameter of tubing 12. In this application, since ten segments have been chosen, the arc 19 between holes 8a and 8b would be one-tenth of 360 degrees or 36 degrees. The radial location of holes 8a and 8b is approximately midway between the top 20 and what would be the bottom 21 of the segment 7a if there were no concave arc 10. The segment bottom 21 is shown as a dashed line since in reality it does not exist. The radial location of holes 8a and 8b provides optimum closure of any gap between adjacent segments 7a, 7b, and 7c. It was found in practical use that locating holes 8a and 8b at a lower position, closer to the circumference of tubing 12, allowed the adjacent segments 7a, 7b, and 7c to separate, thus providing gaps to appear between the overlapping segments. These gaps are best visualized as being axial in displacement where the upper portion of one segment is displaced from the upper portion of the adjacent segment. This is especially evident when the segment material is thin and quite flexible. Such adjacent segment displacement allows steam or water vapor to pass through the gaps and often extinguishes the torch 32 as shown in FIGS. 6 and 7. Again referring to FIG. 3 it can be seen that the optimum location for the beginning 17 and end 18 of the concave arc 10 is located on the same radial lines 14 and 15 used to locate the center of the holes 8a and 8b. The radius of the concave arc 10 would, for all practical purposes, be equivalent to or slightly larger than the largest tubing 12 diameter to be accommodated by a particular heat shield assembly. The overall width of each segment 7 is designed to provide sufficient overlap with adjacent segments to reduce any flexure that might occur between adjacent segments which, in turn, could result in undesirable inter-segment gaps, allowing steam or water vapor to pass between.

FIG. 4 is an exploded, cross sectional, side view, showing segments 7a and 7b, rivet 24, and spring washer 25. The assembly procedure consists of inserting the rivet 24 thru the hole in the upper segment 7a, the spring washer 25 and the lower segment 7b. A first pressure would be applied by a mechanism such as a clamp to compress the segments and spring washer to a predetermined point where a second deforming pressure from another mechanism, such as a hydraulic press, would be applied to the rivet.

FIG. 5 shows a side view of the above items in which, as a result of the second pressure, the end of rivet 24 has been deformed and represented as item 26. This operation would be repeated as needed to interconnect all the segments, thus forming the complete heat shield assembly 11 of FIG. 2. The heat shield assembly 11 as shown composed of several segments allows the heat shield to be adjusted to fit around tubing or pipes of varying diameters. When required a conventional clamping device such as a paper clamp or clip can be used to secure any over lapping segments together. In the event an application involves a tube or pipe of very large diameter, more than one heat shield assembly can be clamped together to encompass the required circumference.

FIG. 6 shows a typical application in which the heat shield assembly might be used. A typical valve 27 is used in a plumbing, refrigeration, air conditioning or similar application. The objective is to connect the valve 27 so as to make it an integral part of an overall system. This connection takes the form of attaching valve input pipe 28, which is part of valve 27, and system input pipe 29. As shown, system input pipe 29 is first inserted in the enlarged section 30 of valve input pipe 28. Next, the heat shield assembly 11 is adjusted to fit around the circumference of valve input pipe 28 in a position between the area to be heated and the valve 27. The heat source 32 is typically a butane or oxy-acetylene torch. The flame 33 produced by heat source 32 heats the desired area allowing solder or brazing material 31 to melt and flow into the junction between the system input pipe 29 and the enlarged section 30 of valve input pipe 28. This produces a leak-tight seal. The valve output pipe 34 from valve 27 would be soldered or brazed to a system output pipe, not shown, in a similar manner. It can be seen that the heat shield assembly 11 reduces the radiant heating of valve 27 since it provides a barrier between the heat source 32 and the valve 27. Likewise, the heat shield assembly 11 reduces the discoloration of the valve 27 that often occurs during the soldering or brazing process. In some situations the pipe to be soldered or brazed is adjacent to a wall surface and care must be used to avoid damaging the wall surface. In this case the heat shield can often be used to prevent radiant heat from damaging the wall surface.

FIG. 7 shows the same arrangement as FIG. 6 with the exception that the valve 27 is totally covered by a rag 35 that has been soaked in water and acts to reduce heating of the valve during the soldering or brazing operation. In this situation heat shield assembly 11 reduces the radiant heating from the heat source to the water-soaked rag. Practical applications have shown that, without the shield, heat from the heat source 32 often scorches or ignites the rag. In addition the heat shield assembly 11 prevents bursts of steam or water vapor emanating from the water-soaked rag from extinguishing the flame 33 of heat source 32. In practical tests the use of the heat shield assembly 11 has been shown to be extremely useful, since frequent extinguishing of the heat source or torch 32 by bursts of steam or water vapor delays completion of the soldering or brazing. Such delays, requiring re-igniting of the torch 32, extend the time that heat must be applied. A technician typically strives to complete the soldering or brazing operation as quickly as possible in order to reduce the amount of time that heat is applied and thus the amount of heat transferred to the valve 27 or any other such system component.

In summary, the heat shield assembly described above, offers a practical solution to at least two problems often encountered by service technicians when soldering or brazing components in plumbing, refrigeration, and air conditioning systems. As previously mentioned, the two most common problems solved by the heat shield assembly are first, the reduction of radiant heat from a heat producing source, and second, reducing the possibility of steam or water vapor emanating from a water-soaked rag from extinguishing the heat source or torch flame. Although the above description primarily deals with soldering or brazing of such systems it should be understood that it should not preclude the use of the heat shield in other appropriate applications, such as welding. It should be understood that anyone skilled in the art could determine other applications without departing from the spirit of the invention.

What is claimed is:

1. A heat shield assembly comprising;
a plurality of intermediate segments and two end segments;
each segment formed from a material that would not be significantly damaged by the application of heat from an external heat source;
each of the plurality of intermediate segments having two holes allowing adjacent segments to be attached to one another;
said two end segments having at least one hole allowing attachment to an adjacent segment; and
a fastening means inserted through holes in adjacent segments allowing each segment to move independently of its adjacent segment.

2. A heat shield assembly of claim 1 wherein;
a bottom portion of each segment shaped in a concave arc to allow close conformance with the outside diameter of an object to be shielded.

3. A heat shield assembly of claim 1 wherein;
a friction producing means placed between adjacent segments at the point where one segment is fastened to its adjacent segment.

4. A heat shield assembly of claim 3 wherein;
the friction producing means is a spring washer or wavy washer.

5. A heat shield assembly of claim 1 wherein;
the fastening means is a rivet.

6. A heat shield assembly of claim 1 wherein;
each hole is located approximately midway between the top and bottom of the segments.

7. A heat shield assembly comprising;
a plurality of segments each having a top portion and a bottom portion;
means for attaching said plurality of segments together; and
a concave arc in said bottom portion allowing for close conformance with the outside surface of an object to be shielded.

8. A heat shield assembly of claim 7 wherein;
the attaching means is located approximately midway between the top portion and the bottom portion of each segment.
